(19) United States
(12) Patent Application Publication
(10) Pub. No.: US 2017/0083869 A1
(43) Pub. Date: Mar. 23, 2017

(54) SYSTEM AND METHOD FOR EMPLOYMENT RECOMMENDATION

(71) Applicants: Sumit JAIN, New Delhi (IN); Vijay Mendiratta, New Delhi (IN)

(72) Inventors: Sumit JAIN, New Delhi (IN); Vijay Mendiratta, New Delhi (IN)

(21) Appl. No.: 15/268,386

(22) Filed: Sep. 16, 2016

(30) Foreign Application Priority Data
Sep. 18, 2015 (IN) 2961/DEL/2015

(51) Int. Cl. G06Q 10/10; G06F 7/08

(52) U.S. Cl. CPC G06Q 10/1053; G06F 7/08

(57) ABSTRACT

An efficient and well-organized system 100 and method 200 for provisioning job searching as well as candidate searching are disclosed. Said system 100 comprises a user management module 102 for receiving user related information; a processing unit 104 for processing said user related information; an employer module 106 for receiving the employer related information; a detecting unit for identifying at least one vacancy available with at least one said employer and at least one user with a matching user's profile data; a recommendation unit 110 to establish a relationship between the said employer, the matching user and at least one of its contacts based on the employer profile data, user profile data and the contact profile data and a request unit 112 for enabling user to send a request for a referral for said vacancy to said at least one contact identified in the said relationship, by the user depending upon his input/s.

### FIELD OF INVENTION

The present invention generally relates to a system and method for employment recommendation and more particularly, to a networking system and method for creating a meta-data/connection between job seekers/users, his contacts and employers/recruiters, wherein the user has an option to request a referral from his contacts for job positions.

### BACKGROUND OF INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and not as admissions of prior art.

Job searching systems have been widely used by job seekers for finding suitable jobs, and by recruiters for finding suitable candidates for their job positions. In conventional methods, job postings were usually provided via newspapers, bulletin boards, advertisements or recruitment agencies. However, these methods are inefficient for the job seekers as only a limited number of candidates become aware of the current job offers.

This lead to the introduction of online job portals/sites that provided a platform for searching and providing jobs by maintaining a database of job seekers and recruiters. In an event when an employer needs to hire a candidate employed for a particular post/opening/position, then the employer identifies candidates possessing required skills and/or qualifications via said platform. Thus, these online job portals facilitate job seekers in finding jobs according to their profile, and job recruiters in finding the desired candidates meeting all their requirements.

However, in some cases, it can be a challenging task to identify suitable candidates for a job position. Also, it becomes difficult for the job seekers to find attractive positions, even when there are many vacancies in the field. Likewise, these methods are inefficient since they inform about current job positions to only those job seekers who have either applied for such positions or are continuously active on such sites and thus, these methods are unable to inform the passive members of the system i.e. members who have not applied for the job position but may be interested and/or appropriate for such positions, if approached. Since the most suitable job seekers/members may be unaware of the current job positions, the efficiency to find suitable candidates is reduced.

Another reason for the failure of the current online job portals/system/sites is that such systems are unable to connect the job seekers/members to recruiters/other job seekers. Also, a number of fraudulent recruitment agencies are targeting young candidates looking to make successful career i.e. various fraudulent hiring firms are luring candidates with the promise of better jobs and salaries. Another limitation of conventional systems lies in the failure to efficiently sort the selected candidates for a desired job position on the basis of parameters such as candidate's skills, experience, academic qualifications, etc. Yet another limitation of conventional systems is lack of efficient referral method/mechanism. Therefore, there is a need for developing effective and reliable job recommendation systems and methods that enable job seekers to easily find suitable jobs as well as provides job seekers an option of requesting a referral from his friend/contact for a particular job opening.

### SUMMARY OF INVENTION

This section is provided to introduce certain objects and aspects of the disclosed methods and systems in a simplified form that are further described below in the detailed description. This summary is not intended to identify the key features or the scope of the claimed subject matter.

In view of the shortcomings of existing methods and systems, as discussed in the background section, it is apparent that there exists a need for developing a more efficient and user-friendly networking system and method to substantially reduce the limitations of the prior art systems. It is therefore an object of the disclosed invention to provide an employment recommendation method and system that can also be used as a referral method to enable a user to use his contacts/friends as a referral to the organization where he wants to apply for a job position. This is done by establishing meta-data/connections between the candidates/users, his friends/contacts and recruiters/employers.

Another object of the present invention is to provide a reliable employment recommendation method and system to enable job seekers/users as well as employers to easily discover suitable jobs and candidates respectively without the risk of fraudulent organizations/companies/job seekers. Yet another object of the present invention is to provide a networking method and system to notify at least one of the user, contact, and the employer in respect of information relating to available employers, vacancies, etc.

In view of the abovementioned objects, the present invention aims at providing a well-organized method and system for provisioning job searching as well as candidate searching. More particularly, the present invention relates to a system for employment recommendation comprising a memory, wherein said memory comprises one or more program instruction modules that comprises a user management module 102 for receiving user related information from at least one data source, wherein the user related information comprises user's profile data of at least one user and profile data of at least one contact of said at least one user; a processing unit 104 configured to process the user related information received from user management module 102, wherein the processing includes categorization of the user profile data and the contact profile data based on pre-configured rules; an employer module 106 for receiving employer related information from at least one data source, wherein the employer related information comprises profile data of at least one employer and is normalized; a detecting unit 108 for receiving information from said processing unit 104 and said employer module 106 and identifying at least one vacancy available with at least one said employer and identifying at least one user with a matching user's profile data; a recommendation unit 110 configured to create a meta-data to establish relationship between the said employer, the matching user and at least one of its contacts based on information received from detecting unit, wherein the recommendation unit 110 notifies at least one of the user, contact, and the employer of said relationship; a request unit configured to enable the user to send a request regarding a referral for said vacancy with said employer, to said at least one contact identified in the said relationship; and a processor operable to execute the one or more program instruction modules.

Further, the present invention discloses a system for generating and displaying an employment recommendation in a graphical user interface. Said system comprises a first input means for receiving, a user related information from at least one data source, wherein the user related information comprises user's profile data of at least one user and profile data of at least one contact of said at least one user; a pre-processing means adapted to receive user related information from said first input means and processing said user related information, wherein said processing includes categorization of the user profile data and the contact profile data based on pre-configured rules; a second input means for receiving employer related information from at least one data source, wherein the employer related information comprises profile data of at least one employer; a processing means adapted to receive information from said first input means and said second input means, and identifying at least one vacancy available with at least one said employer and identifying at least one user with a matching user's profile data, and creating a meta-data to establish relationship between the said employer, the matching user and at least one of its contacts based on the information received by the detecting unit 106 and an output means adapted to receive information from said processing means, for notifying the user and/or the employer of said relationship by the recommendation unit 110, wherein a request regarding a referral for said vacancy with said employer is sent by the user to said at least one contact identified in the said relationship, depending upon user's input.

Further, the present invention discloses a method for employment recommendation. Said method comprises steps of receiving said user related information from at least one data source by user management module; processing said information received from user management module by the processing unit, wherein the processing includes categorization of the user profile data and the contact profile data based on pre-configured rules; receiving the employer related information from at least one data source by an employer module, wherein the employer related information comprises profile data of at least one employer; identifying at least one vacancy available with at least one said employer and at least one user with a matching user's profile data by the detecting unit; creating a meta-data/connection to establish a relationship between the said employer, the matching user and at least one of its contacts based on the employer profile data, user profile data and the contact profile data; notifying the user and/or the employer of said relationship by the recommendation unit and sending a request for a referral for said vacancy to said at least one contact identified in the said relationship, by the user depending upon his input/s.

Other objects, features, and advantages of the present invention will become apparent from the following detailed description.

### DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings include invention of electrical components or circuitry commonly used to implement such components. Also, the embodiments shown in the figures are not to be construed as limiting the invention, but the possible variants of the employment recommendation method and system according to the invention are illustrated herein to highlight the advantages of the invention.

FIG. 1 illustrates a general overview of the system architecture wherein the system includes different modules/units working together in accordance with the principles of the invention to couple the information of user/s, his contact/friends and employer/s.

FIG. 2 illustrates a flowchart depicting the employment recommendation method in accordance with the present invention.

FIG. 3 illustrates a graphical representation of connections i.e. a meta-data in accordance with one of the embodiments of the present invention.

### DETAILED DESCRIPTION OF EXEMPLARY EMBODIMENTS

In the following description, for the purposes of explanation, various specific details are set forth in order to provide a thorough understanding of the disclosed embodiments. It will be apparent, however, that the disclosed embodiments may be practiced without these specific details. Several features described hereafter can each be used independently of one another or with any combination of other features. However, any individual feature may not address any of the problems discussed above or might address only some of the problems discussed above. Some of the problems discussed above might not be fully addressed by any of the features described herein. Although headings are provided, information related to a particular heading, but not found in the section having that heading, may also be found elsewhere in the specification. Further, information provided under a particular heading may not necessarily be a part of only the section having that heading.

As used herein, a ‘user's device’ refers to any electrical, electronic equipment or a combination of one or more of the above devices. User's devices may include, but not limit to, a mobile phone, smart phone, pager, laptop, a general purpose computer, desktop, personal digital assistant (PDA), tablet computer, mainframe computer, or any such device as may be obvious to a person skilled in the art. In general, said device is a digital, user configured, computer networked device that can operate autonomously. It is one of the appropriate systems for storing data and/or other related information.

As used herein, a ‘user management module’ refers to any part/component of the system that is adapted/configured to receive user related information from a plurality of data sources and subsequently storing the same.

As used herein, a ‘processor unit’ includes one or more processors, wherein the processor refers to any digital computer possessing logic, intelligent and analytical skills for processing any type of information/data. A processor may include but not limit to a general purpose processor, a special purpose processor, a conventional processor or a combination of such processors, as may be obvious to a skilled person. The processor may be adapted to perform data processing, input/output processing, categorizing said data, inputs/outputs; normalizing said data and/or any other functionality that enables working of the system according to the present invention.

As used herein, an ‘employer module’ refers to any part/component of the system adapted to receive employer related information from a plurality of data sources and subsequently store the same.

As used herein, a “detecting unit” refers to any part/component that identifies available vacancies/job openings, suitable candidates/job seekers/users and/or a combination of one or more of the data, as may be obvious to person skilled in the art.

As used herein, an ‘analytics unit’ refers to any part/component of the system adapted for creating a meta-data/connection between the user/candidate, his contacts/friends and employers and further analysing/co-relating user/candidate, his contacts/friends and employers located therein. The analytics unit may include but not limit to an analyser, a mapping tool etc. for performing above mentioned functions. Further, the analytics unit is adapted to store the abovementioned data for future use.

As used herein, an “alert unit” refers to any part/component of the system that notifies information relating to job recommendation, to at least one of the user, contact, and the employer.

As used herein, an “input means” may be one of a keyboard, mouse, camera, touchpad or any such device as may be obvious to person skilled in the art.

As used herein, an “output means” may be one of a display, printer, speaker or any such device as may be obvious to person skilled in the art.

As used herein, “memory” refers to a random access memory (RAM), read only memory (ROM), a hard disk drive (HDD), a secure digital (SD) card or any such memory as may be obvious to person skilled in the art.

As used herein, ‘social network’ refers to any social structure or an online site/portal that comprises information relating to its members/users. It also comprises information relating to job openings, job seekers/candidates, employers. The social network is adapted to provide a brief analysis about entire social entities as well as a variety of concepts/logics explaining the same.

As used herein, ‘data source’ refers to any data directory such as user's phonebook, email contact list/s, contacts details listed in social networking sites (such as facebook, twitter, etc.) or a combination of such data, as may be obvious to a person skilled in the art.

As used herein, a ‘notification’ is a wireless signal that conveys information to the user/candidate, his contact/friend and employer. Said notification may include but not limit to information relating to job recommendation such as number of available suitable job openings; number of suitable candidates; relation between the user/candidate, his contact/friend and employer; any update or information regarding the user, his contacts or the employer; or any other information or a combination of any of the aforementioned, as may be obvious to a person skilled in the art.

As used herein, a ‘contact’ and its cognate terms such as ‘user's contact’ or ‘user's connection’ or ‘user's friend’ or ‘user's relative’ etc. may include other people acquainted or associated to the user as identifiable via the data source.

As used herein, ‘user related information’ refers to data relating to profile data of the user himself (user profile data) or of at least one of his contacts (i.e. contact profile data), wherein the user profile data may include personal details such as name, contact number, contact address, academic details comprising his academic scores, college/institute, his technical skills, achievements or any such detail, as may be obvious to a person skilled in the art; professional details comprising his work experience, internships, current and previous projects or any such detail, as may be obvious to a person skilled in the art; and professional skills comprising his strengths and weakness in the professional field. Further, the contact profile data as encompassed by the present invention may comprise similar details of the user's contacts as are mentioned above for the user.

As used herein, ‘employer related information’ refers to data relating to employer profile data, wherein the employer profile data may include employer's background details, employee's details such their basic profiles, education and work history; partnerships/associated partners, services/products available, available internships and job opening/vacancy, achievements or any such detail, as may be obvious to a person skilled in the art.

As used herein, “connect”, “configure”, “couple” and its cognate terms, such as “connects”, “connected”, “configured” and “coupled” may include a physical connection (such as a wired/wireless connection) or any other suitable connection, or a combination of such connections, as may be obvious to a skilled person.

As used herein, “send”, “transfer”, “transmit”, and their cognate terms like “sending”, “sent”, “transferring”, “transferred”, “transmitted”, etc. include sending or transporting data from one unit to another unit/module, wherein the data/information may or may not be modified before or after sending, transferring, transmitting.

As used herein, “receive” and its cognate terms like “receiving”, “received”, etc. include receiving data from one unit to another unit/module, wherein the data/information may or may not be modified before or after sending, transferring, transmitting.

System Overview

A method and system for employment recommendation, in accordance with the present invention, is described herein-below.

In general, the networking system and method, in accordance with exemplary embodiments of the present disclosure, deal with the personal, social, academic, professional details of millions of users for the purpose of creating a meta-data/connection which in turn facilitates detailed analysis of said meta-data for efficient employment recommendation. It is encompassed that the system 100 allows the users to decide how their details, available on the system 100, will be displayed to other users of the system 100 as well as their own contacts/friends and employers. In this manner, the user may manage display of their details or even block all or any specific person (user/contact/employer) to view his details, available on the system 100.

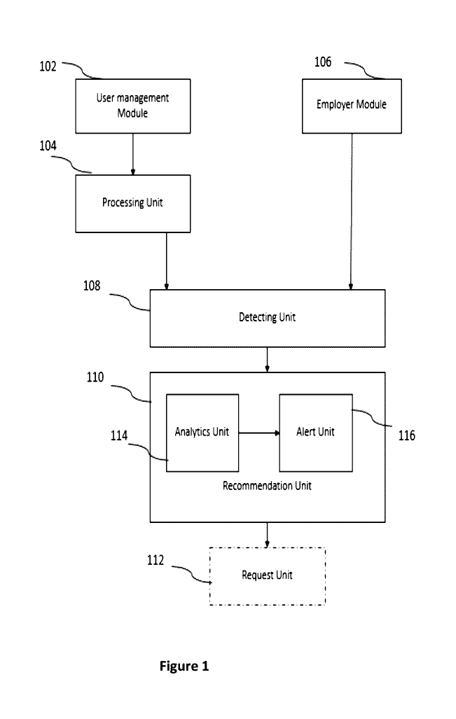

FIG. 1 is a general overview of the system architecture wherein the system 100 includes different modules/units working together in accordance with the principles of the invention to couple the information/data of users, contacts of user and employers under the process of employment recommendation. Also, the system 100 and its modules/units are organised/arranged in such a manner that they are capable of identifying and analysing relationship/connection between said information and thereby notifying said analysis to at least one of the user, contacts, employer of said relationship. Moreover system 100 may be adapted to operate completely or in parts at a device level, a server level or a combination thereof.

Additionally, a graphical user interface comprises a first input means, a pre-processing means, a second input means, a processing means and an output means.

More particularly, the system 100, as shown in the FIG. 1, comprises a user management module 102; a processing unit 104; an employer module 106; a detecting unit 108 and a request unit 112 for enabling the proper functioning of the system, in accordance with the invention.

The system for employment recommendation further contains a memory comprising at least one program instruction module, wherein said at least one program instruction module comprises a user management module 102 for receiving user related information from at least one data source, a processing unit 104 configured to process the user related information received from user management module 102; an employer module 106 for receiving employer related information from at least one data source; a detecting unit 108 for receiving information from said processing unit 104 and said employer module 106; a recommendation unit 110 configured to create a meta-data to establish relationship between the said employer, the matching user and at least one of its contacts; a request unit configured to enable the user to send a request regarding a referral for said vacancy with said employer to said at least one contact identified in the said relationship and a processor operable to execute the one or more program instruction modules.

In an exemplary embodiment of the present invention, a pre-processing unit is coupled to the input means. It is further is configured to fetch a set of instructions and execute the set of instructions. The pre-processing unit 104 may be realized through a number of processor technologies known in the art. Also, a processing means adapted to receive information from said first input means and said second input means, and identifying at least one vacancy available with at least one said employer and identifying at least one user with a matching user's profile data, and creating a meta-data to establish relationship between the said employer, the matching user and at least one of its contacts based on the information received by the detecting unit 106.

The user management module 102 of the system 100 is adapted to capture data from the at least one data source such as phonebook, email contacts, social networking sites etc. of at least one user in order to ascertain or assess the user related information. Said user related information includes user profile data and at least one of his contacts i.e. contact profile data, wherein the user profile data may include personal details, academic details, professional details, professional skills etc. Further, said contact profile data comprises same information as that of the user. The captured/received data is stored within a memory that either resides at a central server level or is present internally in the system 100 itself.

Further, the invention encompasses that the user management module 102 periodically receives the user related information from at least one said data source wherein, the period limit of receiving may be fixed by either system 100 or user or may be dynamically updated at any time. In an exemplary embodiment, the system 100 updates said information the moment user makes any changes in his data source or information.

The user management module 102 is further connected to a processing unit 104 configured to receive the data from the user management module 102. The processing unit 104 processes said data by categorizing the user related information i.e. user profile data and the contact profile data based on pre-configured rules followed by the normalization of categorized data. The processing unit 104 consists of various rules and/or strategies to categorize the data according to a variety of users or contacts. These rules are defined by the system 100, user or a combination thereof. Periodical or dynamic updating of said rules is also encompassed by the present invention. Further, the processed data/categorized data is converted into a standardized format to enable smooth and efficient processing for further use. Said format is either defined by the system 100, user or a combination thereof such that it is easily compatible with the user's device, data source, system 100, employer's device, etc.

The employer module 106 is adapted to receive/capture data from the at least one data source such as phonebook, email contacts, social networking sites, etc. of at least one employer in order to ascertain or assess the employer related information. Said employer related information may include employer's background details, partnerships/associated partners, services/products available, available internships and job opening/vacancy, achievements etc. The captured/received data is stored within a memory that either resides at a central server level or is present internally in the system 100 itself. Also, the employer module 106 is adapted to convert the captured/received data into a standardized format to enable smooth and efficient processing for further use. Said format is either defined by the system 100, user or a combination thereof such that it is easily compatible with the user's device, data source, system 100, employer's device etc.

The detecting unit 108 is connected to the processing unit 104 and employer module 106 to receive the normalized information relating to the user, contact and employer. Further, it is also adapted to identify at least one vacancy available with at least one said employer and identifying at least one user with a matching user's profile data based on user related information and employer related information.

The recommendation unit 110 is connected to the detecting unit 108 to receive said normalized information. Said recommendation unit 110 comprises of analytics unit 114 for creating a meta-data and alert unit 116 for notifying at least one of the user, contact, and the employer of said relationship.

The analytics unit 114 is adapted to consider all the information/data (i.e. information identified by detecting unit 108 and the normalized information containing employer profile data, user profile data and the contact profile data) received from detecting unit 108 to create a meta-data for further analysis. The invention encompasses that the meta-data includes educational data and professional data, wherein the educational data enables the user to discover connections in his college, schools, institutes, etc. associated with an employer where the user wishes to apply for a job and the professional data, enables the user to discover his connections associated with an employer where the user wishes to apply for job. The invention also encompasses that the meta-data may be updated on addition of new data sources of the user/employer/contact which in turn may have new information.

Further, the meta-data is analysed to identify available job openings/vacancies, suitable candidates/users, contacts of said user/candidate etc. and establish a relationship between the said employer, the matching user and at least one of its contacts based on the information received from detecting unit 108. More particularly, the analytics unit 114 is adapted to generate recommendation based on said established relationships. Also, the analytics unit 114 may identify users as well as employers as per suitable jobs and candidates and/or his contacts respectively. The present invention also encompasses storage of the information relating to the meta-data, said relationship, and identified users, contacts, employers. However, the storage of such details/information is dependent either on the user, the system 100 or a combination thereof, whereby it may also be decide which of said details/information needs to be stored for further use. In one of the embodiments of the present invention, the system 100 consists of historical data relating to captured, received, processed information, meta-data, notifications etc. wherein the settings/display of said historical data can be either modified by the system 100, user or a combination thereof.

Further, said recommendation, generated by the analytics unit 114, is subsequently sent to alert unit 116 present in recommendation unit 110 for notifying at least one of the user, contact, and the employer of said relationship. The present invention encompasses sending of notification to said user, contact, and the employer through emails, text messages, postal messages, phone calls, alert message on the system 100 or a combination thereof. The present invention also encompasses that the user has an option to either accept the notification regarding the recommendation or ignore it or even take an action based on said notification.

The request unit 112 is connected to the recommendation unit 110 to facilitate a referral medium for the user. Said referral medium may facilitate the user to request to his contact/friend for a referral regarding a particular job/employer, identified as associated with a prospective employer based on the meta-data/established relationship, wherein said request may be sent through a text message, a phone call, email etc.

Also, said request may include but not limit to details relating to user related information etc. Such referrals may facilitate relations/connections between said employer seeking for suitable employees and user. However, the system 100 acts as a referral medium in accordance with only the user's inputs i.e. it is totally dependent on the user to decide whether or not he wishes to use a referral.

Though only a limited number of user management modules 102, processing units 104, employer modules 106, detecting units 108, recommendation units 110 and referral unit 112 have been shown in FIG. 1, however, it will be appreciated by person skilled in the art that the networking system 100 of the present invention, for employment recommendation, encompasses any number and varied types of user management modules 102, processing units 104, employer modules 106, detecting units 108, recommendation units 110, referral unit 112 or any other components, as may be obvious to a person skilled in the art, that may be necessary to implement the broad concept encompassed by this invention.

Method Overview

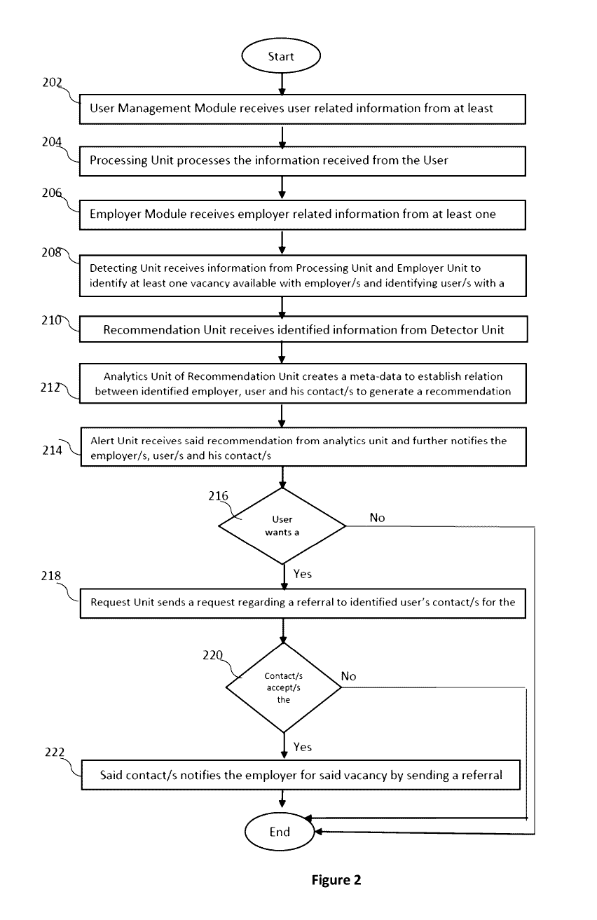

FIG. 2 describes a high level step by step employment recommendation mechanism with the flow of action/s and/or information performed/involved in the whole process. FIG. 2 describes the process of providing information or details regarding the available employer/s, vacancies, etc., when a user allows the system 100 to access at least one of his data source to perform activities in accordance with the present invention. Thus, to initiate said mechanism, the system 100 requests the user to allow the system 100 to access user related information from at least one data source. In the event, the user has allowed the system 100 to access said details, system 100 is authorized for said access, pursuant to which the method leads to step 202. On the contrary, if the user does not allow the system 100 to access said details, the process of employment recommendation halts and comes to end. In an embodiment of the present invention, the system 100 once allowed to access said details can automatically lead to the step 202; however the user, at any moment, can stop the system 100 for said access.

Step 202 includes receiving of user related information from at least one data source of the user such as phonebook, email, social networking sites, etc., by the user management module 102, wherein receiving user related information comprises receiving personal details, academic details, professional details, etc. of the user and his at least one contact. The present invention encompasses periodic and automatic receiving and storing of said information. In an embodiment of the present invention, the user, at any moment, can select any data source/s among the accessed data sources to stop the system 100 from accessing. For example, if the user does not want the system 100 to access his phonebook any longer, he can accordingly instruct the system 100. In another embodiment of the present invention, the user, at any moment, can add data source/s to the list of already accessed data sources to allow the system 100 to access said additional data source/s.

Step 204 includes processing, the received user related information, by the processing unit 104, wherein user related information includes user profile data and contact profile data. As an initial stage of processing said information, the processing unit 104 categorizes said information (user profile data and contact profile data) in accordance with preconfigured rules. The invention encompasses multiple versions/methods/criteria for categorizing the same. For instance, the information may be categorized under different parameters such as contacts, school, colleges/institutions, hobbies, technical strengths and weaknesses etc. This categorization of user related information enhances following steps of the process. Further, the processing unit 104, after categorization of the data, converts said categorized data into a standardized format, wherein said format is defined by the system 100 or the user or combination thereof such that the standardized information is easily compatible with the user's device, data source, system 100, employer's device etc.

Step 206 includes receiving of employer related information from at least one data source of the employer by employer module 106, wherein receiving employer related information comprises receiving employer's details, partnerships/associated partners, services/products available, available internships and job opening/vacancy, achievements etc. The present invention encompasses periodic and automatic receiving and storing of said information. In an embodiment of the present invention, the employer, at any moment, can select the data source/s among the accessed data sources that he wishes the system 100 to stop accessing. For example, if the employer does not want the system 100 to access his phonebook any longer, he can instruct the system 100 for the same. In another embodiment of the present invention, the employer, at any moment, can add data source/s to the list of already accessed data sources to enable the system 100 to access said additional data source/s. Further, the received employer related information is converted into a standardized/normalized format, wherein said format is defined by the system 100 or the employer or combination thereof such that the standardized information is easily compatible with the user's device, data source, system 100, employer's device etc.

Step 208 includes receiving of normalized information (from processing unit 104 and employer module 106) comprising employer profile data, user profile data and the contact profile data, by the detecting unit 108. Subsequently, at least one vacancy available with at least one said employer and identifying at least one user with a matching user's profile data based on user related information and employer related information are identified.

Step 210 includes receiving the identified information as well as the normalized information (employer profile data, user profile data and the contact profile data) from detecting unit 108 by the analytics unit 114 present in the recommendation unit 110.

Step 212 includes acute consideration of the received information by the analytics unit 114 in order to create a meta-data. The meta-data is created by establishing a relationship/connection for the relevant information i.e. relationship between the employer, matched user and his contact/s, based on received information. In an exemplary embodiment, the meta-data includes an educational link and a professional link, wherein, the educational link enables the user to discover connections in his college, schools, institutes, etc. associated with a company where the user wishes to apply for a job and the professional network enables the user to discover his connections that are/were in the past associated with a company where the user wishes to apply for job. These links display the contact information against each identified connection. In another exemplary embodiment, the meta-data includes possible contacts/friends of the user in each company present in the list of job openings/vacancies. These contacts may be people who are either from the user's own meta-data or ex colleagues/ex batch-mates working in the company where user has applied for a job, details of how the user knows these contacts/friends (i.e. through phonebook/email/social networking sites/college/ex company, etc.). In another exemplary embodiment, the analytics unit 114 can either create a new meta-data or can update already created meta-data by adding new contacts, new employers, and users to the meta-data. Furthermore, based on the connections/relations made and subsequently analysed, a recommendation is prepared/generated. Said recommendation consists of information relating to available jobs, desired candidates/users, user's contacts etc. More specifically, the recommendation advises at least one of suitable employers for the users, suitable candidates for the employers, connections between said employers, users and/or contacts/friends etc. Also, a list of job openings along with the possible connections on the basis of said meta-data is provided in said recommendation. In an exemplary embodiment, in addition to providing a filtered list of said job postings based on available vacancies, a track of the number of candidates responding to the job postings may be provided such that the job seeker can quickly identify other job seekers and can act accordingly. The present invention encompasses flexible and dynamic generation of recommendation based on said meta-data, wherein said recommendation may be either created or may be modified with the existing recommendation.

Step 214 includes receiving of generated recommendation within the recommendation unit 110 i.e. receiving said recommendation from analytics unit 114 by alert unit 116. The alert unit 116 notifies related user/s, his contacts/friends, and employer/s. Said notification may be sent to said related people through emails, text messages, postal messages, phone calls, alert message on the system 100 or a combination thereof wherein the user also has an option to either accept the notification regarding the recommendation or ignore it.

Step 216 includes decision making by the user that whether or not he wishes to use the identified contact/friend in said meta-data and/or notification as a referral. In the event the user wants to seek said referral, the method leads to step 218. On the contrary, if the user does not want to use a referral, the method for employment recommendation halts and comes to end.

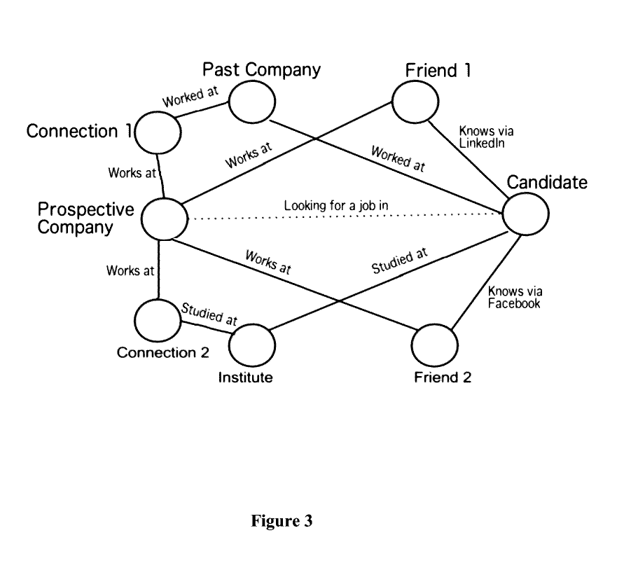

Step 218 includes sending a request to said contact/friend, identified in the meta-data and/or recommendation by a request unit 112, wherein said request may be sent through text message, a phone call, email etc. and may include but not limit to details relating to user related information etc. In an exemplary embodiment, a referral method is implemented in accordance with an exemplary network of meta-data as shown in FIG. 3.

Step 220 includes decision making by the requested contact/friend whether or not he wishes to accept the request from the user. In the event said contact/friend accepts said request, the method leads to step 222. On the contrary, if the contact/friend does not want to accept the referral, the process halts and comes to end.

Step 222 includes forwarding of said referral/request (of the user) to said employer for said vacancy to recommend him for the job opening/vacancy, wherein said notification/referral may include details of suitable candidate/user, etc. Also, said notification/referral may be sent through text message, a phone call, email, etc. However, it depends on the employer whether or not to consider or take further action on said notification/referral.

Thus, the present invention provides a method not only for employment recommendation but also for a referral mechanism wherein the user can refer his contact/friend for a referral in the desired company.

FIG. 3 illustrates a graphical representation a meta-data created between user/candidate, his friends, connections and employer/company/organization where he wishes to apply for a job/vacancy. Said exemplary meta-data consists of 8 nodes: candidate, friend 1, friend 2, institute, past company, connection1, connection2 and prospective company wherein said nodes are linked to each other as shown in the FIG. 3. A candidate, looking for a job position in a prospective company can request a referral from a connection/friend working at the same organization where the candidate wishes to work. The candidate may know the connection/friend through multiple mediums such as his data sources (contact list, email accounts, social networking sites, etc.), his ex-company where he had worked in the past, the college/school that he attended, etc. As shown in the FIG. 3, candidate knows Friend 1 via any social networking site, for example Linkedin, and Friend 2 via other social networking site, for example, Facebook, wherein both Friend 1 and Friend 2 work at the Prospective Company. The Candidate knows Connection 1 who has worked with him in the Past Company. The Candidate knows Connection 2 who has studied with him in the same Institute. Thus, the Candidate can send a referral request to Friend 1, Friend 2, Connection 1 or Connection 2.

Although the present disclosure has been described in considerable detail with reference to certain preferred embodiments and examples thereof, other embodiments and equivalents are possible. Even though numerous characteristics and advantages of the present disclosure have been set forth in the foregoing description, together with functional and procedural details, the disclosure is illustrative only, and changes may be made in detail. Thus various modifications are possible of the presently disclosed system and process without deviating from the intended scope and spirit of the present disclosure.

We claim:

1. A system for employment recommendation comprising:
A memory comprising one or more program instruction modules, the one or more program instruction modules comprising
a user management module 102 for receiving user related information from at least one data source, wherein the user related information comprises user's profile data of at least one user and profile data of at least one contact of said at least one user;
a processing unit 104 configured to process the user related information received from user management module 102, wherein the processing includes categorization of the user profile data and the contact profile data based on pre-configured rules;
an employer module 106 for receiving employer related information from at least one data source, wherein the employer related information comprises profile data of at least one employer and is normalized;
a detecting unit 108 for receiving information from said processing unit 104 and said employer module 106 and identifying at least one vacancy available with at least one said employer and identifying at least one user with a matching user's profile data;
a recommendation unit 110 configured to create a meta-data to establish relationship between the said employer, the matching user and at least one of its contacts based on information received from detecting unit, wherein the recommendation unit 110 notifies at least one of the user, contact, and the employer of said relationship;
a request unit configured to enable the user to send a request regarding a referral for said vacancy with said employer, to said at least one contact identified in the said relationship; and
a processor operable to execute the one or more program instruction modules.

2. The system of claim 1, wherein the data sources may include but not limit to user's phonebook, email contact list, social network's contact details and a combination thereof.

3. The system of claim 1, wherein said profile data of the user and the contact may include personal details, academic details, internships, professional details, professional skills, hobbies or a combination thereof.

4. The system of claim 1, wherein said profile data of the employer may include background details, partners/employee details, services available, product's details, available internships and/or jobs, or a combination thereof.

5. The system of claim 1, wherein said pre-configured rules are defined by the system 100, user or a combination thereof.

6. The system of claim 1, wherein the recommendation unit 110 comprises of an analytics unit 114 for creating and analysing the meta-data and an alert unit 116 for notifying user and/or the employer of said analysis.

7. The system of claim 1 is adapted to operate completely or in parts at a device level, a server level or a combination thereof.

8. An employment recommendation method, wherein the method comprising;
receiving, by user management module 102, the user related information from at least one data source, wherein the user related information comprises user's profile data of at least one user and profile data of at least one contact of said at least one user;
processing said information received from user management module 102 by the processing unit 104, wherein the processing includes categorization of the user profile data and the contact profile data based on pre-configured rules;
receiving, by an employer module 106, the employer related information from at least one data source, wherein the employer related information comprises profile data of at least one employer;
receiving, by the detecting unit 106, the information from processing unit 104 and employer module 106 and identifying at least one vacancy available with at least one said employer and identifying at least one user with a matching user's profile data;
creating a meta-data to establish relationship between the said employer, the matching user and at least one of its contacts based on the information received by the detecting unit 106,
notifying the user and/or the employer of said relationship by the recommendation unit 110;
sending, by the user, a request regarding a referral for said vacancy with said employer, to said at least one contact identified in the said relationship, depending upon user's input.

9. The method of claim 8, comprises normalizing the processed user related information by processing unit 104 and employer related information by employer module 106 into a standardized format wherein said format is pre-defined by the system 100 or by the user

10. A system for generating and displaying an employment recommendation in a graphical user interface comprising:
a first input means for receiving, a user related information from at least one data source, wherein the user related information comprises user's profile data of at least one user and profile data of at least one contact of said at least one user;
a pre-processing means adapted to receive user related information from said first input means and processing said user related information
wherein said processing includes categorization of the user profile data and the contact profile data based on pre-configured rules;
a second input means for receiving employer related information from at least one data source, wherein the employer related information comprises profile data of at least one employer;
a processing means adapted to receive information from said first input means and said second input means, and
identifying at least one vacancy available with at least one said employer and identifying at least one user with a matching user's profile data, and creating a meta-data to establish relationship between the said employer, the matching user and at least one of its contacts based on the information received by the detecting unit 106,
an output means adapted to receive information from said processing means, for notifying the user and/or the employer of said relationship by the recommendation unit 110, wherein a request regarding a referral for said vacancy with said employer is sent by the user to said at least one contact identified in the said relationship, depending upon user's input.

11. The system of claim 10 wherein said first input means and said second input means may be one of a keyboard, mouse, camera and touchpad.

12. The system of claim 10 wherein said output means may be one of a display, printer and speaker.
